(19) United States
(12) Patent Application Publication
(10) Pub. No.: US 2008/0294888 A1
(43) Pub. Date: Nov. 27, 2008

(54) DEPLOY TARGET COMPUTER, DEPLOYMENT SYSTEM AND DEPLOYING METHOD

(76) Inventors: Masahiko ANDO, Yokohama (JP); Akira Kato, Yokohama (JP); Sumio Goto, Fujisawa (JP)

Correspondence Address: MILES & STOCKBRIDGE PC, 1751 PINNACLE DRIVE, SUITE 500, MCLEAN, VA, 22102-3833, US

(21) Appl. No.: 12/024,337

(22) Filed: Feb. 1, 2008

(30) Foreign Application Priority Data
May 21, 2007 (JP) 2007-133825

(51) Int. Cl. G06F 9/00

(52) U.S. Cl. 713/2

(57) ABSTRACT

A deploy target computer is connected to a storage device including a replication source logical disk used to store a boot disk image. A disk mapping processing part in the deploy target computer changes over access destination so as to set the access destination to the replication source logical disk in the storage device when an I/O request is issued from the deploy target computer to the storage device and the I/O request specifies reading the boot disk image, and so as to set the access destination to a replication destination logical disk for conducting writing concerning the boot disk image when the I/O request specifies writing concerning the boot disk image.

### INCORPORATION BY REFERENCE

The present application claims priority from Japanese application JP2007-133825 filed on May 21, 2007, the content of which is hereby incorporated by reference into this application.

### BACKGROUND OF THE INVENTION

1. Field of the Invention

The present invention relates to a technique for deploying a boot (start) disk image in a computer (deploy target computer) such as a server.

2. Description of the Related Art

In recent years, flexible server construction according to a business load is demanded in operation of a system including a large number of servers. In other words, specifically, shortening of the server construction time is first demanded. For the server construction, it becomes necessary to deploy a boot disk image in a server. Here, the boot disk image refers to an image obtained when a program required for the server to boot is installed in a storage area. Hereafter, however, it is represented by “OS (Operating System) image” (or “image” or “disk image”).

When deploying an OS image in a server, a deployment system first extracts inherent information of the server such as a computer name and network related information from a storage area in which the OS is stored, and generates a master disk. Thereafter, the deployment system delivers a master disk image via a network in response to a deploy order, and copies the image onto a local disk in the server. The deployment is regarded as completed when the copy is completed. By the way, the master disk may be generated so as to contain inherent information of the machine. In this case, it is necessary to rewrite the inherent information by using a dedicated program after copy of the master disk.

In such a conventional technique, a load is applied to the network because the disk image is delivered to the deploy target server via the network, and it takes time until the deployment completion because of network restriction such as communication band restriction. And the time required until the deployment completion increases as the capacity of the master disk increases, and quick scale out of the system cannot be coped with. If as many master disks as the number of deploy target servers are prepared beforehand, a large number of replicas become necessary and the burden on a system manager is heavy. In US2005/0223210A1 (Sasaki et al), therefore, a deployment technique capable of quickly providing a provision destination of an OS image with an OS image stored in a logical volume in a storage system is disclosed.

A deployment method disclosed in US2005/0223210A1 is a technique for conducting deployment quickly in a system in which a plurality of information processing terminals and at least one storage system are connected to a first communication network and a deployment machine is connected to a second communication network (for example, a SAN (Storage Area Network)) which is faster in operation than the first communication network, by copying OS image data stored in a logical volume in a storage system to a logical volume for server via the second communication network.

### SUMMARY OF THE INVENTION

Even if a fast communication network is used to copy the OS image, however, some time is required to conduct the copying and consequently it takes some time (for example, approximately one hour) until the copying is completed and the deploy target server is brought into a state where the boot can be started. The present invention has been made in view of these problems, and an object thereof is to bring the deploy target server into the state where the boot can be started, in a short time.

The present invention provides a deploy target computer which is connected to a storage device including a replication source logical disk used to store a boot disk image functioning as a program for starting and which becomes a target of deployment of the boot disk image.

The deploy target computer includes a disk mapping processing part for changing over an access destination so as to set the access destination to the replication source logical disk in the storage device when an I/O request is issued from the deploy target computer to the storage device and the I/O request specifies reading the boot disk image, and so as to set the access destination to a replication destination logical disk provided in the storage device, the deploy target computer or an external computer to conduct writing concerning the boot disk image when the I/O request specifies writing concerning the boot disk image. Other means will be described later.

According to the present invention, the deploy target server can be brought into the state where the boot can be started, in a short time by the changeover of the access destination conducted by the disk mapping processing part.

Other objects, features and advantages of the invention will become apparent from the following description of the embodiments of the invention taken in conjunction with the accompanying drawings.

### BRIEF DESCRIPTION OF THE DRAWINGS

FIG. 1 is a general configuration diagram of a deployment system according to a first embodiment;

FIG. 2 is a functional block diagram of a target server;

FIG. 3 is a diagram for explaining processing of changing a device of access destination conducted by a disk mapping processing part when an I/O is issued from an OS;

FIG. 4 is a configuration diagram of a mapping state management table stored in a disk mapping processing part;

FIG. 5 is a configuration diagram of a reflection information table stored in a storage subsystem;

FIG. 6 is a configuration diagram of a master image management table stored in a storage subsystem;

FIG. 7 is a configuration diagram of a data reflection management table stored in a data reflection part in a storage subsystem;

FIG. 8 is a configuration diagram of mapping information managed by a mapping information management part;

FIG. 9 is a flow chart showing processing conducted by a disk mapping processing part in response to an I/O request from an OS;

FIG. 10 is a flow chart of processing conducted by an I/O analysis part in a disk mapping processing part;

FIG. 11 is a flow chart of processing conducted by a physical device control part in a disk mapping processing part;

FIG. 12 is a flow chart of processing conducted by a data reflection completion detection part in a disk mapping processing part;

FIG. 13 is a flow chart of a write processing request stored in a data reflection management table in a storage subsystem;

FIG. 14 is a flow chart of processing conducted by a data reflection part in a storage subsystem; and

FIG. 15 is a general configuration diagram of a deployment system according to a second embodiment.

### DESCRIPTION OF THE EMBODIMENTS

Hereafter, embodiments of the present invention will be described.

### First Embodiment

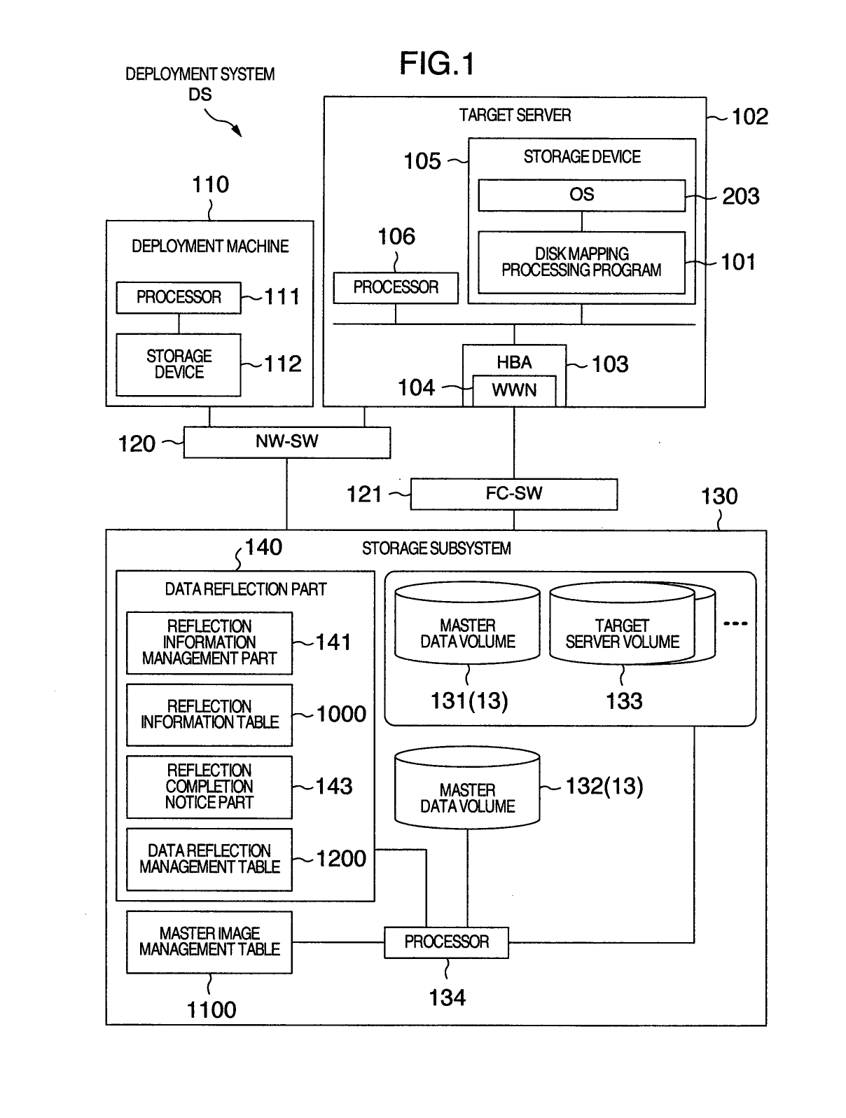

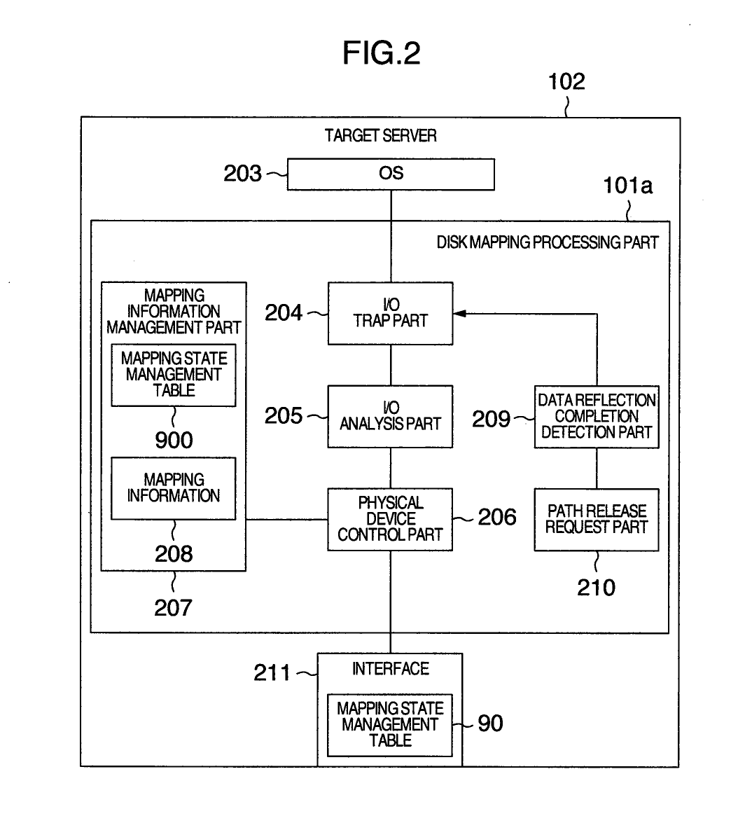

FIG. 1 is a general configuration diagram of a deployment system according to a first embodiment of the present invention. In a deployment system DS, a deploy target server 102 (deploy target computer) including a disk mapping processing program 101 includes an HBA (Host Bus Adapter) 103 for conducting fiber channel communication. The deploy target server 102 is connected to a storage subsystem 130 (storage device) storing an OS (Operating System) image to be deployed via a FC-SW (Fiber Channel Switch) 121. Furthermore, a deployment machine 110 for issuing a deploy instruction, the target server 102, and the storage subsystem 130 are connected via a NW-SW (NetWork Switch) 120. In the target server 102, a processor 106 and the disk mapping processing program 101 are collectively referred to as disk mapping processing part 101a (which will be described with reference to FIG. 2 later).

The OS image is one form of the boot disk image (which is a general term of images required for the target server 102 to boot). If an image to be deployed is a boot disk image, the boot disk image may include an application image besides the OS image. Each image refers to a state in which its pertinent program is stored in hardware (a state in which driver setting and the like have been conducted).

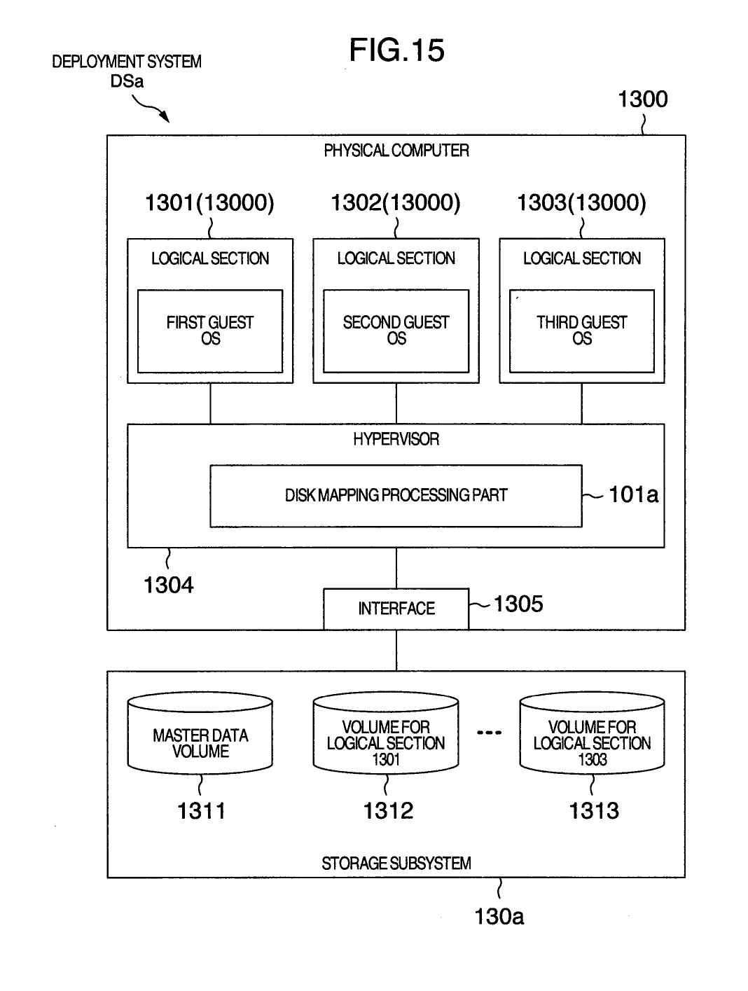

In FIG. 1, only one target server 102 is shown. However, it is not always necessary to have only one target server 102, but a plurality of target servers 102 may exist. As for the disk mapping processing part 101a (see FIG. 2), it is sufficient that at least one exists in the target server 102. Specifically, in the case where the present invention is implemented by using a virtualization technique as in a second embodiment shown in FIG. 15, the disk mapping processing part 101a may exist in a virtualization mechanism (for example, a hypervisor 1304). The second embodiment will be described in detail with reference to FIG. 15 later. In the first embodiment, the target server 102 is connected to the storage subsystem 130 via a SAN. Here, the case where the SAN is an FC-SAN is described. Therefore, the SAN includes at least one FC-SW 121.

By the way, the SAN need not be a FC-SAN, but may be, for example, an IP (Internet Protocol)-SAN. In such a case, the target server 102 may be connected to the NW-SW 120 instead of the FC-SW 121, and a different NW-SW for communicating with the storage system 130 may be used. In the case where a different NW-SW is provided as a dedicated SW for communicating with the storage subsystem 130, relaxation of network communication restrictions caused by, for example, dissipation of communication bands can be anticipated.

By the way, the HBA 103 is an interface (corresponding to an interface 211 shown in FIG. 2) for communicating with an external device by using a fiber channel. A WWN 104 is a value of a memory on the HBA 103 in which a WWN (World Wide Name) is stored. Since the WWN 104 is a value unique to each HBA, the external device can discriminate the HBA 103 on the basis of the WWN 104. If the IP-SAN is used instead of the FC-SAN, then the communication interface included in the target server 102 is formed of an iSCSI adaptor and an iSCSI name is used for communication with the storage subsystem 130 instead of the WWN 104.

The target server 102 includes a storage device 105 (for example, a memory or the like) storing an OS 203 and a disk mapping processing program 101, and a processor 106 (for example, a CPU (Central Processing Unit)) for executing the disk mapping processing program 101. The disk mapping processing program 101 is a program for changing over an access destination device of an I/O (Input/Output) request (input/output request, which is simply referred to as I/O as well hereafter) in order to make the OS 203 believe that the OS image copying is instantaneously completed. The processor 106 executes the disk mapping processing program 101 (in other words, the disk mapping processing part 101a (see FIG. 2) operates). By conducting only path setting for the storage subsystem 130 after detecting deploy manipulation from the deployment machine 110, it becomes possible for the target server 102 to instantaneously start boot processing and bring the OS into operation. Processing required to change over the access destination device in response to an I/O request will be described in detail with reference to FIG. 2 later.

The storage subsystem 130 which is an external storage device is a storage device including a processor 134 for arithmetic operation, a logical volume (for example, a virtual disk which can be identified by using a logical unit or the like), a disk controller, and a data reflection part 140. The storage subsystem 130 is, for example, a RAID (Redundant Arrays of Inexpensive Disks) system constituted by arranging a large number of disk-type storage devices (physical disks) on an array. Logical volumes include master data volumes 131 and 132 (which are hereafter referred to as “master data volume 13” unless especially distinguished) (replication source logical disk) for retaining an OS image which becomes an origin of deployment, and a target server volume 133 (corresponding to the target server 102 in one-to-one correspondence) (replication destination logical disk) for target server 102 to be accessed by the target server 102 other than the master data volume. There may be a plurality of master data volumes and a plurality of target server volumes. Each logical volume is assigned a logical volume ID (Identification) for uniquely identifying the logical volume. Access from the outside is conducted by specifying the logical volume ID.

Although only one storage subsystem 130 is shown in FIG. 1, a plurality of storage subsystems 130 may be included. As for a form in which a plurality of storage subsystems 130 are included, a case where a storage device different from the storage subsystem 130 that retains the master data volume 13 is disposed as a device for storing the target server volume 133 is conceivable. In other words, a configuration in which the target server 102 can access the master data volume 13 and the target server volume 133 is needed. Specifically, it is also conceivable as an embodiment to prepare the master data volume 13 in the storage subsystem 130 and make the target server volume 133 a storage device (for example, a hard disk) included in the target server 102.

The data reflection part 140 included in the storage subsystem 130 is a processing part for copying data in the master data volume 13 to the target server volume 133. It is not always necessary that the data reflection part 140 is included in the storage subsystem 130, but the data reflection part 140 may be included in an external computer connected to the devices retaining the master data volume 13 and the target server volume 133.

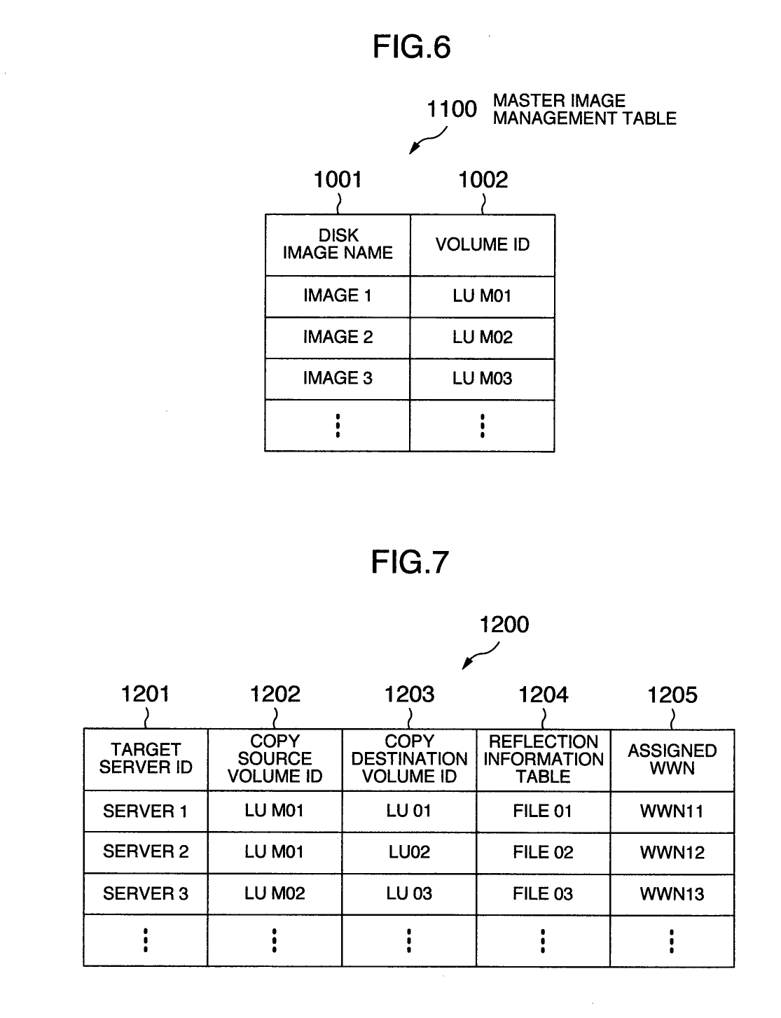

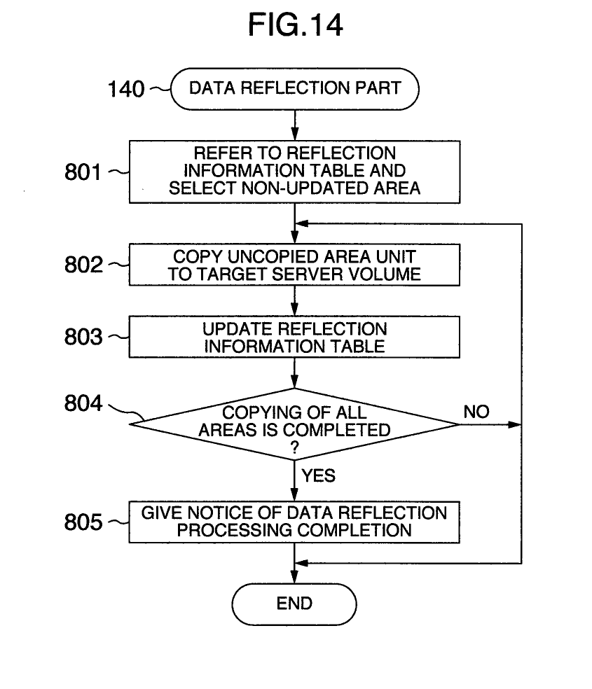

The data reflection part 140 includes a reflection information management part 141, a reflection information table 1000 (which will be described with reference to FIG. 6 later), a reflection completion notice part 143, and a data reflection management table 1200. Processing conducted in the data reflection part 140 will be described in detail with reference to FIG. 14 later. By the way, the data reflection management table 1200 may not be provided in the data reflection part 140 but may be provided in other place in the storage subsystem 13.

The storage subsystem 130 further includes a master image management table 1100 (which will be described with reference to FIG. 6 later).

The deployment machine 110 is, for example, a computer such as a personal computer. The deployment machine 110 includes an interface (not illustrated) for network connection. The deployment machine 110 further includes a processor 111 (for example, a CPU), and a storage device 112 (for example, a memory or a hard disk) for storing deployment software used to order deployment. The deployment machine 110 further includes a communication device (not illustrated) required to order the target server 102 to conduct deployment and request the storage subsystem 130 storing the master data volume 13 and the target server volume 133 to set a path to the WWN 104 in the HBA 103 included in the target server 102. The processor 111 executes deployment software stored in the storage device 112 and issues a deploy instruction to the target server 102 and the master data volume 13. Thereby the deployment machine 110 implements a deploy order function. Heretofore, the general configuration of the deployment system DS shown in FIG. 1 has been described.

The disk mapping processing part 101a included in the target server 102 will now be described with reference to FIG. 2. FIG. 2 is a functional block diagram of the target server.

As shown in FIG. 2, the disk mapping processing part 101a includes an I/O trap part 204, an I/O analysis part 205, a physical device control part 206, a mapping information management part 207 having mapping information 208 and a mapping state management table 900, a data reflection completion detection part 209 and a path release request part 210. The disk mapping processing part 101a forms one of features of the present embodiment different from the conventional technique.

The I/O trap part 204 conducts processing for trapping an I/O request issued from the OS 203. The I/O trap part 204 is a processing part for exercising control to, for example, prevent trap processing from being executed after a notice that all data in the master data volume 13 have been reflected to the target server volume 133 is received from the data reflection completion detection part 209 which will be described later. The I/O analysis part 205 is a processing part for analyzing an I/O request trapped by the I/O trap part 204 (i.e., for determining whether the I/O request is a read request or a write request).

The physical device control part 206 is a processing part for dynamically changing an access destination device of an I/O request as occasion demands in cooperation with the mapping information management part 207. The physical device control part 206 judges a request classification (read/write) for a target server device (the master data volume 13 or the target server volume 133) included in contents analyzed by the I/O analysis part 205, and changes the access destination device dynamically. By the way, the physical device control part 206 may be, for example, a part that includes a device driver such as a disk driver and that conducts processing to change an access destination of an I/O request. A driver such as an HBA adaptor may have the function of the physical device control part 206. Or the physical device control part 206 may be firmware.

The mapping information management part 207 includes the mapping state management table 900 and the mapping information 208, and manages information required by the physical device control part 206 to change over the I/O destination. The mapping information management part 207 updates the mapping state management table 900 on the basis of information input/output by the interface 211 (an upper concept of the HBA 103).

The data reflection completion detection part 209 detects a data reflection completion notice from the reflection completion notice part 143 that the data reflection part 140 (which will be described in detail later) in the storage subsystem 130 has. Upon detecting the completion of the processing of reflecting the master data volume 131 to the target server volume 133, the reflection completion detection part 209 notifies the path release request part 210 of the completion state and conducts execution of the access path setting release request to the master data volume 13. The path release request part 210 is a processing part for requesting release of an assigning state of the WWN 104 to the master data volume 131 included in the storage subsystem 130 when the reflection completion detection part 209 has detected completion of the data reflection.

Hereafter, an outline of processing for causing the target server 102 which has received a deploy instruction from the deployment machine 110 to be able to boot instantaneously in the deployment system DS according to the first embodiment shown in FIG. 1 will be described.

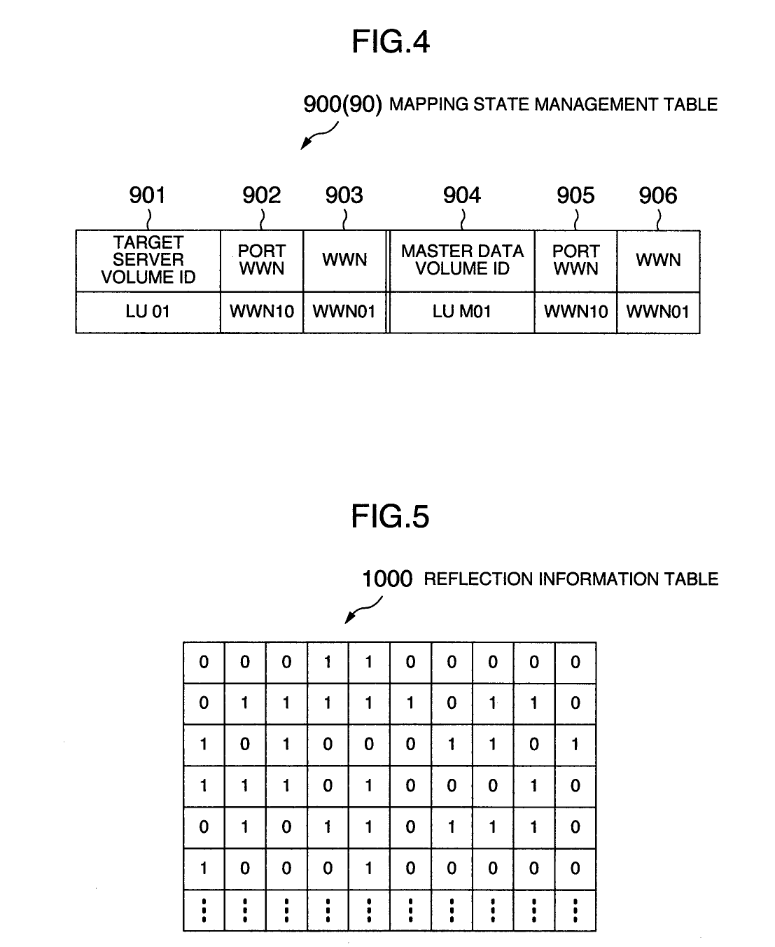

First, the deployment machine 110 issues a deploy order concerning the target server 102. Specifically, the deployment machine 110 conducts assignment of logical volume IDs of the master data volume 131 and the target server volume 133 included in the storage subsystem 130 and the host bus adapter (HBA 103) included in the target server, and registers a target server ID (column 1201), a copy source volume ID (column 1202), a copy destination volume ID (column 1203), a reflection information table (column 1204) and an assigned WWN (column 1205) in the data reflection management table 1200 (FIG. 7) managed by the data reflection part 140, by using the assigned information. Subsequently, the deployment machine 110 registers information required to access the assigned master data volume 131 and access the target server volume 133 into a mapping state management table 90 (see FIG. 4) in the interface 211, and changes the boot path required for the target server 102 to boot to the master data volume 131.

As for concrete registration into the mapping state management table 90 included in the interface 211 and the boot path setting method, it is conceivable that the deployment machine 110 distributes a program for table update processing and boot path setting. If thereafter power supply control processing (for example, using magic packet transmission based on “Wake On LAN” technique or the like) is executed on the target server 102 and a power supply of the target server 102 is turned on, then data required for boot processing of the target server 102 are read out from the master data volume 131 and the target server 102 can start the boot.

In other words, if only a time required for path setting in the storage subsystem 130 has elapsed, then the boot processing of the target server 102 can be started without waiting for the completion of copying of the master data volume 131 to the target server volume 133. Therefore, it becomes possible to instantaneously cope with a case where prediction is difficult such as scale-out for the target server 102 rapidly increased in load. By the way, the scale-out means assigning a new target server 102 to the system configuration. Heretofore, the outline ranging from the deploy instruction to start of the boot processing conducted by the target server 102 in the first embodiment has been described.

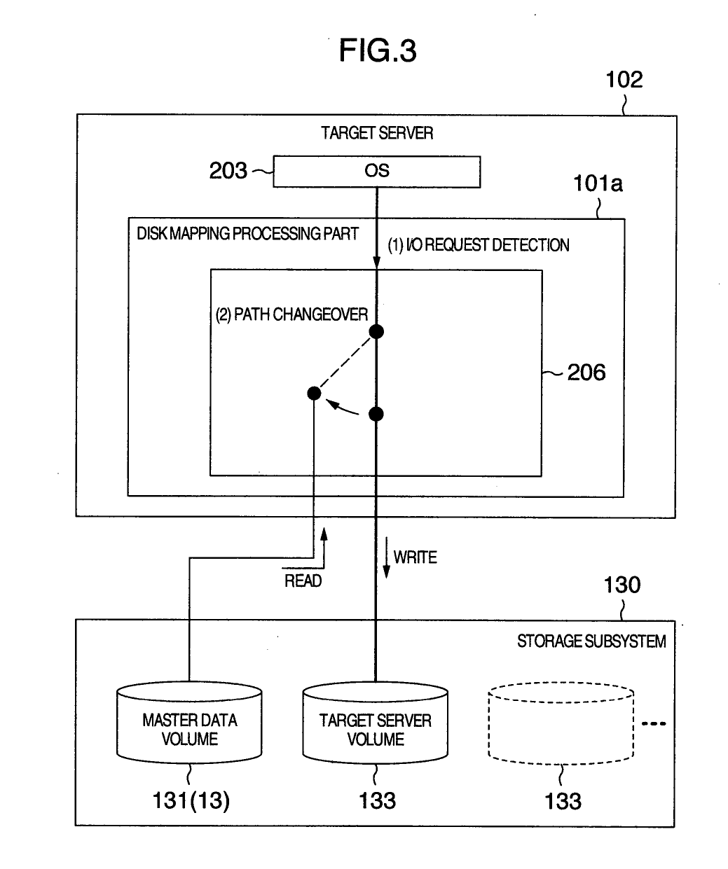

FIG. 3 is a diagram for explaining processing of changing a device of access destination conducted by the disk mapping processing part when an I/O is issued from the OS. If an I/O request is issued from the OS 203 in the target server 102, then the physical device control part 206 in the disk mapping processing part 101a accesses the target server volume 133 retained by the storage subsystem 130. The disk mapping processing part 101a does not show a path for accessing the master data volume 131 to the OS 203 operating on the target server 102, but shows a path for accessing the target server volume 133 to the OS 203. Therefore, the OS 203 need not be conscious of selection of the access destination device, and an I/O request to the master data volume 131 is not generated. As described earlier, the physical device control part 206 dynamically changes access to a logical volume included in the storage subsystem 130. Therefore, a virtual volume obtained by putting together data in the master data volume 131 and data in the target server volume 133 is provided without making the OS 203 be conscious of accessing the master data volume 131.

FIG. 4 is a configuration diagram of a mapping state management table stored in the disk mapping processing part. The mapping state management table 900 includes a target server volume ID (column 901), a WWN of a port in the storage subsystem 130 storing the target server volume 133 (column 902), a WWN of an HBA 103 included in the target server 102 and assigned to the target server volume 133 (column 903), a master data volume ID (column 904), a WWN of a port in the storage subsystem 130 storing the master data volume 13 (column 905), a WWN of an HBA 103 included in the target server 102 and assigned to the master data volume 131 (column 906).

Values of respective columns are generated by the processor 106 in response to a deploy order from the deployment machine 110, and are referred to by the path release request part 210 in the disk mapping processing part 101a or the like. By the way, it is not always necessary that the mapping state management table 900 includes all columns shown in FIG. 4, but it is sufficient that the disk mapping processing part 101a retains information for accessing the master data volume 131 and the target server volume 133.

FIG. 5 is a configuration diagram of the reflection information table stored in the storage subsystem. The reflection information table 1000 stores information for managing states required for volume copy conducted by the data reflection part 140. A state as to whether to copy from the master data volume 131 to the target server volume 133 is managed using 1-bit information (“0” and “1”) with an area taken as the unit (for example, with a sector taken as the unit). In the reflection information table 1000, the state can be managed by, for example, setting the state for an area that requires copying to “1” and setting the state for an area that does not require copying to “0” as shown in FIG. 5. In other words, it is sufficient to be able to determine whether copying is necessary every area.

By the way, the reflection information table 1000 generated from the data reflection management table 1200 (see FIG. 7) is a table also referred to and updated from the data reflection part 140 which will be described with reference to FIG. 14 later. The reflection information table 1000 is a table used by the data reflection part 140 to manage whether to conduct copying from the master data volume 131 to the target server volume 133.

FIG. 6 is a configuration diagram of the master image management table stored in the storage subsystem. The master image management table 1100 is used to manage a disk image name 1001 and a volume ID 1002 retained in the storage subsystem 130. The master image management table 1100 shows a list of logical volumes (master data volumes 13) used as master data. By the way, as for logical volumes used as master data, path setting is conducted in the state of write inhibit (read only) when conducting path setting for the target server 102.

FIG. 7 is a configuration diagram of the data reflection management table stored in the data reflection part in the storage subsystem. The data reflection management table 1200 includes the target server ID (column 1201), the copy source volume ID (column 1202), the copy destination volume ID (column 1203), the reflection information table (column 1204), and the assigned WWN (column 1205). The data reflection management table 1200 is generated by the processor 134 in response to, for example, a deploy order from the deployment machine 110.

The target server ID (column 1201) is a unique identifier by which a target server 102 executing deployment can be discriminated (identified). The copy source volume ID (column 1202) uniquely identifies a logical volume area assigned as the master data volume 131 of the target server 102. The copy destination volume ID (column 1203) is an identifier of a logical volume area assigned as the target server volume 133. The reflection information table (column 1204) identifies a reflection information table 1000 which retains a copy state between volumes required by the data reflection part 140 to execute asynchronous copy (which is not synchronized with the operation of the disk mapping processing part 101a). The assigned WWN (column 1205) is a value of the WWN 104 in the HBA 103 included in the target server 102.

By the way, a certain copy source volume ID (column 1202) is not associated with only a specific copy destination volume ID (column 1203), but a plurality of copy destination volume IDs (column 1203) may be associated with one copy source volume ID (column 1202). Specifically, this is needed, for example, when deploying a certain master data volume 13 in a plurality of target servers 102.

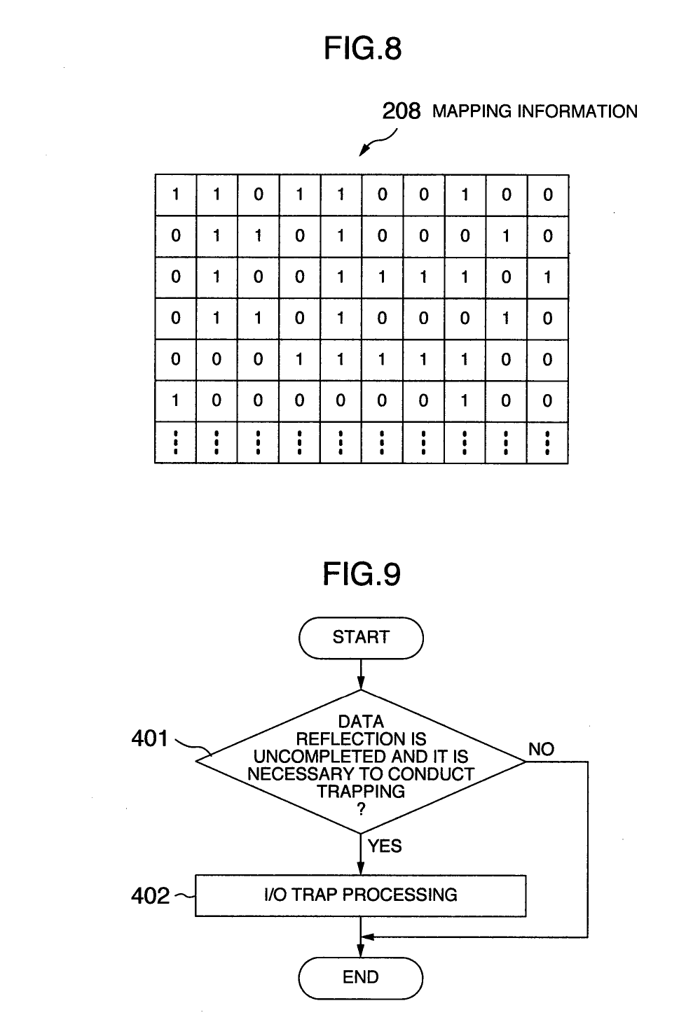

FIG. 8 is a configuration diagram of mapping information managed by the mapping information management part. The mapping information 208 is information required for the physical device control part 206 to make a decision whether to change over the access destination device of the I/O. The mapping information 208 is used to manage whether data is already written into the target server volume 133 (whether data in the master data volume 131 is already replicated) by taking an area as the unit (for example, taking a sector as the unit). The state can be managed by, for example, setting an area already written into the target server volume 133 to “1” and setting an area which is not yet written into the target server volume 133 to “0” as shown in FIG. 8. In other words, it is sufficient only to be able to determine whether an area for which a request is issued from the physical device control part 206 is already written into the target server volume 133.

Subsequently, concrete processing conducted in the deployment system DS will be described.

FIG. 9 is a flow chart showing processing conducted by the disk mapping processing part in response to an I/O request from the OS. The present processing is started by issuance of an I/O from the OS 203. At step 401, the disk mapping processing part 101a makes a decision whether data reflection from the master data volume 131 to the target server volume 133 conducted by the data reflection completion detection part 209 is not completed and it is necessary to conduct trapping. If the data reflection is not completed and it is necessary to conduct trapping (yes at the step 401), then at step 402 the disk mapping processing part 101a conducts trapping on an I/O issued from the OS 203, and executes the physical device control part 206 which is processing for changing the I/O request as occasion demands (see FIG. 11). If the data reflection is completed and it is not necessary to conduct trapping (no at the step 401), then the disk mapping processing part 101a finishes the processing.

By the way, the I/O request from the OS 203 is access to a target server volume 133 that can be accessed from the target server 102 in which that OS 203 is operating. If it is judged at the step 401 that the data reflection is completed, therefore, it is possible to execute access to the device without conducting I/O trap processing and without changing the I/O request from the OS 203 at all. In other words, the disk mapping processing part 101a needs to access the master data volume 131 as occasion demands until data in the master data volume 131 is completely reflected to the target server volume 133. After the data in the master data volume 131 is completely reflected to the target server volume 133, however, the disk mapping processing part 101a need not access the master data volume 131, but needs to access only the target server volume 133.

The decision whether the data reflection is completed at the step 401 is made by the data reflection completion detection part 209 in the disk mapping processing part 101a which will be described later.

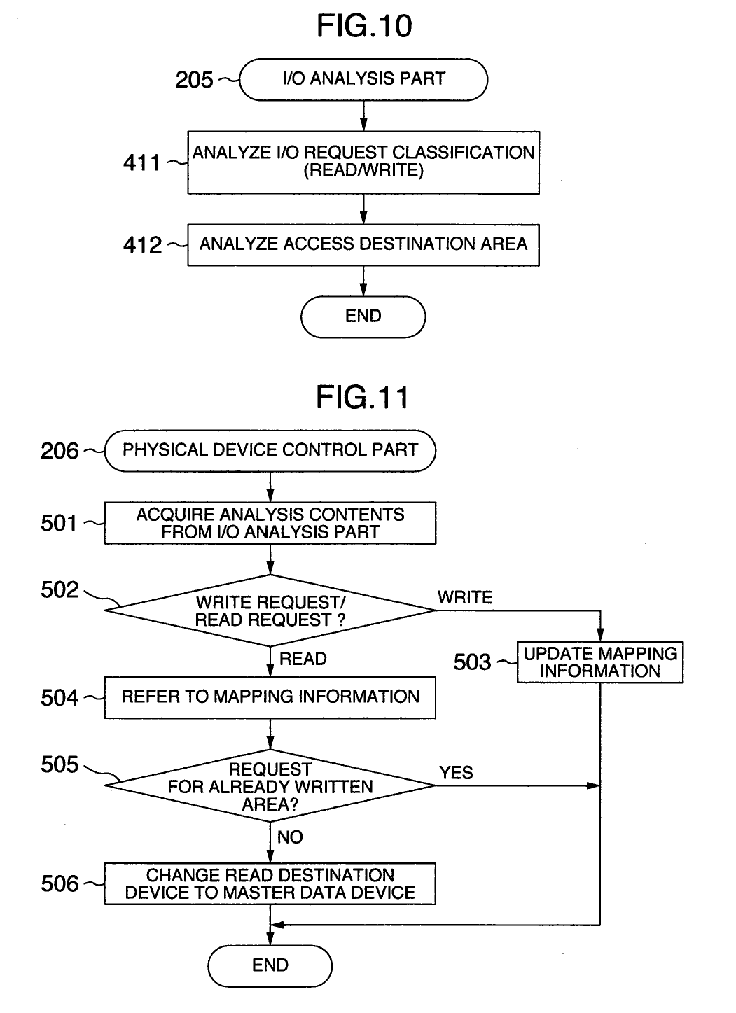

FIG. 10 is a flow chart of processing conducted by the I/O analysis part in the disk mapping processing part. The present processing is executed when the OS 203 issues an I/O and it is necessary to trap the I/O (yes at the step 401 in FIG. 9). The I/O analysis part 205 analyzes a request classification of the I/O issued from the OS 203 and obtains a classification result of “read” or “write” as a result of the analysis (step 411). Subsequently, the I/O analysis part 205 conducts analysis as to which area is to be accessed (analysis of the access destination area) (step 412). Results of these analyses are delivered to the physical device control part 206.

FIG. 11 is a flow chart of processing conducted by the physical device control part in the disk mapping processing part. The present processing is executed after the processing conducted by the I/O analysis part 205 (the processing shown in FIG. 10), when the OS 203 issues an I/O and it is necessary to trap the I/O (yes at the step 401 in FIG. 9).

At step 501, the physical device control part 206 acquires a request classification (write/read) of the trapped I/O request and the access destination area from the I/O analysis part 205. At step 502, the physical device control part 206 makes a decision whether the request classification obtained at the step 501 is read or write. If a result of the decision is a write request, the physical device control part 206 executes step 503.

At step 503, the physical device control part 206 updates the mapping information 208 managed by the mapping information management part 207. Specifically, the physical device control part 206 changes a state of the mapping information 208 corresponding to the access destination area acquired at the step 501 to an already written state (see FIG. 8). After the step 503, the physical device control part 206 finishes the present processing.

On the other hand, if the request classification at the step 502 is the read request, step 504 is executed. At the step 504, the physical device control part 206 refers to the mapping information 208 managed by the mapping information management part 207. Thereafter, the physical device control part 206 executes step 505. At the step 505, the physical device control part 206 makes a decision whether the area to be accessed in the I/O acquired at the step 501 is already written into the target server volume 133. If the request is a read request for an already written area (yes at the step 505), the access is regarded as access to the target server volume 133 without changing the trapped I/O request. If at the step 505 the request is a read request for an area that is not written (no at the step 505), then the physical device control part 206 refers to the mapping state management table 900 retained by the mapping information management part 207, acquires information (information in the column 904, the column 905 and the column 906) required to access the master data volume 131, and changes the access destination in the I/O request to the master data volume 131 (step 506).

Heretofore, the I/O changeover conducted by the physical device control part 206 has been described with reference to FIG. 11. By conducting this processing, the physical device control part 206 conducts unitary management on I/O requests issued from the OS 203 to the target server volume 133 and dynamically changes the access destination device as occasion demands. As a result, it becomes possible to always provide the OS 203 with a disk image after deployment. In other words, it is possible to cause the OS 203 operating on the target server 102 including the disk mapping processing part 101a to believe that the deployment is instantaneously completed.

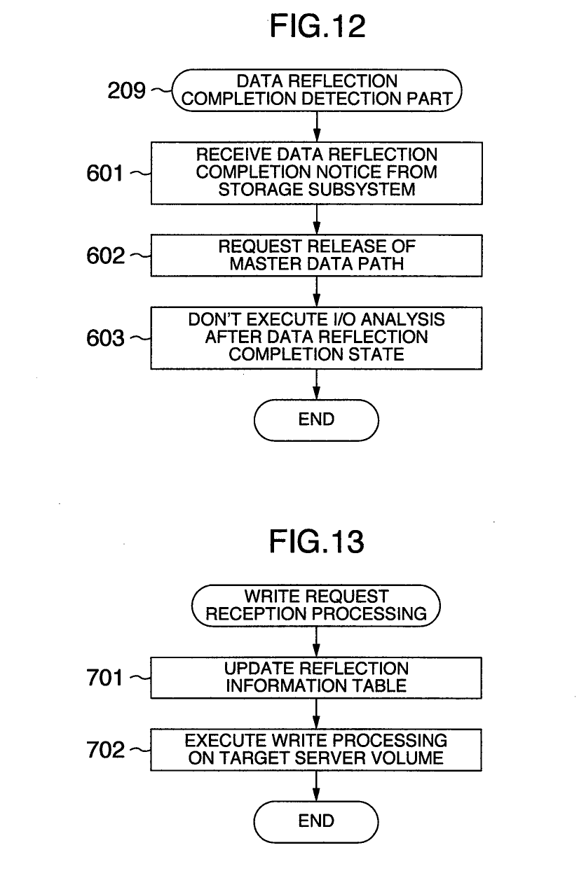

FIG. 12 is a flow chart of processing conducted by the data reflection completion detection part in the disk mapping processing part. Upon receiving a data reflection completion notice from the storage subsystem 130 (step 601), the data reflection completion detection part 209 executes a release request for the path to the master data volume 131 (step 602). At the step 602, the data reflection completion detection part 209 refers to the mapping state management table 900 (see FIG. 4) stored in the mapping information management part 207 included in the disk mapping processing part 101a, acquires the master data volume ID in the column 904, the WWN of the port in the storage subsystem 130 storing the master data volume 131 in the column 905, and the value of the WWN 104 stored in the memory of the HBA 103 included in the target server 102 in the column 906, and requests the storage subsystem 130 to release the path for accessing the master data volume 131. Upon accepting the path release request, the storage subsystem 130 analyzes the accepted request and conducts disconnection of the pertinent path by using the assigned WWN and logical volume ID.

Upon receiving a notice that the path release has completed from the storage subsystem 130, the data reflection completion detection part 209 recognizes a data reflection completion state, and brings about a state in which the I/O trap processing (I/O analysis) is not executed in response to an I/O request from the OS 203 (stops the analysis) (step 603). The data reflection completion detection part 209 refers to the mapping state management table 900 stored in the mapping information management part 207 included in the disk mapping processing part 101a, acquires the target server volume ID in the column 901, the WWN of the port in the storage subsystem 130 storing the target server volume 133 in the column 902, and the value of the WWN 104 stored in the memory of the HBA 103 included in the target server 102 in the column 903, and updates the boot path set in the interface 211 to the target server volume 133.

FIG. 13 is a flow chart of a write processing request stored in the data reflection management table in the storage subsystem. The present processing is started when the processor 134 has received a write request for a logical volume (the master data volume 13 or the target server volume 133) included in the storage subsystem 130 from an external computer such as the target server 102.

The processor 134 retrieves an ID corresponding to a logical volume (copy destination volume) to be subject to write processing from the column 1203 in the data reflection management table 1200 stored in the storage subsystem 130, and refers to the reflection information table (column 1204) in the hit pair (row). And the processor 134 changes (updates) a state in a location for the corresponding area of the write request in the reflection information table 1000 identified from the column 1204 to a state in which copying is not to be conducted (step 701).

After the step 701, the processor 134 executes write processing on the requested logical volume (target server volume 133) (step 702).

FIG. 14 is a flow chart of processing conducted by the data reflection part in the storage subsystem. The present processing is executed asynchronously with the I/O request changeover conducted by the disk mapping processing part 101a. The present processing is processing of copying the master data volume 131 to a corresponding target server volume 133 while taking the already copied state into consideration. At step 801, the data reflection part 140 discriminates a copy destination volume ID (an ID of the target server volume 133) stored in the column 1203 in the data reflection management table 1200, derives a corresponding copy source volume ID (an ID of the master data volume 131) from the column 1202, and determines a pair to be copied. Thereafter, the data reflection part 140 discriminates a reflection information table of that pair from the column 1204, refers to the reflection information table 1000, and selects an area where update resulting from copying is not yet conducted (by taking, for example, a sector as the unit).

With respect to two volumes included in the pair, the data reflection part 140 copies an area of the master data volume 131 to be copied to a specific area in the corresponding target server volume 133 at step 802. And the data reflection part 140 updates the corresponding area in the reflection information table 1000 to the already copied area state at step 803. At step 804, the data reflection part 140 checks whether all areas in the reflection information table 1000 are already copied areas. If copying of all areas is not completed (no at the step 804), the data reflection part 140 returns to the step 802, and executes similar copy processing repetitively with respect to all areas.

If copying of all areas is completed (yes at the step 804), then the data reflection part 140 judges all areas to be in the copy completion state at step 805, and causes the reflection completion notice part 143 to notify the data reflection completion detection part 209 in the disk mapping processing part 101a of the data reflection completion state. Since copying is completed, the data reflection part 140 deletes places of the corresponding pair in the data reflection management table 1200 retained by the storage subsystem 130, and deletes the corresponding reflection information table 1000.

In this way, according to the deployment system DS in the first embodiment, the disk mapping processing part 101a changes over the access destination to either the master data volume 131 or the target server volume 133 according to the classification (read/write) of the I/O request. As a result, the disk mapping processing part 101a regards the deployment as completed (regards the state as the state where the boot can be started) without waiting for copy completion of the OS image for the target server 102. Therefore, the target server 102 can start the boot processing instantaneously. Furthermore, since it is not necessary to generate a replica of the OS image beforehand, the disk capacity can be reduced and the utilization efficiency of resources can be raised. In other words, according to the deployment system DS in the first embodiment, it is possible to shorten the time required for server construction, reduce the server construction cost, and implement flexible system operation.

Upon detecting that all data in the master data volume 131 have been copied to the target server volume 133, the disk mapping processing part 101a in the target server 102 disconnects the access path to the master data volume 131. Even if the number of target servers is large, therefore, it is possible to avoid a situation in which accesses concentrate to the master data volume 131.

In addition, copying of data in the master data volume 130 to the target server volume 133 is conducted actively in the storage subsystem 130. As a result, the copy can be completed early.

By the way, each processing in the target server 102 and the storage subsystem 130 can be implemented if a predetermined person generates and executes a program for causing the CPU in the computer to execute the processing.

### Second Embodiment

FIG. 15 is a general configuration diagram of a deployment system according to a second embodiment of the present invention. In a deployment system DSa shown in FIG. 15, a plurality of logical sections 1301, 1302 and 1303 (hereafter referred to as “logical section 13000” unless especially distinguished) are generated by logically dividing physical computer resources included in one physical computer 1300. In this example, the disk mapping processing part 101a is provided in a control program (hypervisor 1304 (VMM: Virtual Machine Monitor)) which controls the logical section 13000 in a logical computer system (not illustrated) capable of simultaneously executing at least one OS (first guest OS to third guest OS (hereafter referred to as “guest OS” unless especially distinguished)).

If the disk mapping processing part 101a is thus provided in the virtualization mechanism, then it becomes unnecessary to provide the disk mapping processing part 101a in the logical section 13000 and it becomes possible for the hypervisor 1304 to manage I/O requests from the guest OSs operating in the logical sections 13000 collectively. In such a case, it is possible to regard virtual servers (not illustrated) operating on a plurality of logical sections 13000 provided on one physical computer 1300 as target servers, and deploy an OS image in a plurality of target servers, and it becomes possible for any target server to start the boot processing instantaneously. Since each concrete processing and effects are similar to those in the first embodiment, description of them will be omitted.

Heretofore, embodiments of the present invention have been described. They are nothing but examples for describing the present invention, and the application range of the present invention is not restricted to the exemplified forms. Furthermore, any combination of the above-described embodiments may become an embodiment of the present invention. In other words, concrete configurations such as hardware and flowcharts can be changed suitable without departing from the spirit of the present invention.

1. A deploy target computer which is connected to a storage device including a replication source logical disk used to store a boot disk image functioning as a program for starting and which becomes a target of deployment of the boot disk image, the deploy target computer comprising:
a disk mapping processing part for changing over access destination so as to set the access destination to the replication source logical disk in the storage device when an I/O request is issued from the deploy target computer to the storage device and the I/O request specifies reading the boot disk image, and so as to set the access destination to a replication destination logical disk provided in the storage device, the deploy target computer or an external computer to conduct writing concerning the boot disk image when the I/O request specifies writing concerning the boot disk image.

2. The deploy target computer according to claim 1, further comprising:
mapping information for managing areas already replicated to the replication destination logical disk and other areas, which are included in the boot disk image stored in the replication source logical disk,
wherein
upon detecting an I/O request to the storage device, the disk mapping processing part analyzes the I/O request,
when the I/O request specifies reading the boot disk image, the disk mapping processing part refers to the mapping information, and makes a decision whether an access destination area of the I/O request is already replicated to the replication destination logical disk, and
if the area is not yet replicated to the replication destination logical disk, the disk mapping processing part changes over the access destination of the detected I/O request to the replication source logical disk.

3. The deploy target computer according to claim 2, wherein as for the mapping information, areas already replicated to the replication destination logical disk and other areas, which are included in the boot disk image stored in the replication source logical disk are managed by using 1-bit information.

4. A deployment system comprising the deploy target computer and the storage device according to claim 2,
wherein
the storage device comprises a data reflection part which operates asynchronously with the disk mapping processing part in the deploy target computer, and the replication destination logical disk, and
the data reflection part in the storage device manages areas that are not replicated to the replication destination logical disk and that are included in the boot disk image stored in the replication source logical disk, and executes replication of the boot disk image to the areas that are not replicated.

5. The deployment system according to claim 4, wherein
upon replicating all of the boot disk image stored in the replication source logical disk to the replication destination logical disk, the data reflection part in the storage device gives a notice that the replication has been completed to the disk mapping processing part in the deploy target computer, and upon receiving the notice, the disk mapping processing part releases a path to the replication source logical disk which stores the boot disk image.

6. The deployment system according to claim 5, wherein after releasing the path to the replication source logical disk, the disk mapping processing part in the deploy target computer stops analysis of the I/O request to the storage device.

7. The deployment system according to claim 4, wherein
the deploy target computer comprises a HBA (Host Bus Adapter) as an interface, and assigns a WWN (World Wide Name) to the HBA as an identifier of the deploy target computer, and
the storage device discriminates the deploy target computer on the basis of the WWN.

8. A deploying method in a deploy target computer which is connected to a storage device including a replication source logical disk used to store a boot disk image functioning as a program for starting, which includes a disk mapping processing part, and which becomes a target of deployment of the boot disk image,
wherein the disk mapping processing part changes over access destination so as to set the access destination to the replication source logical disk in the storage device when an I/O request is issued from the deploy target computer to the storage device and the I/O request specifies reading the boot disk image, and so as to set the access destination to a replication destination logical disk provided in the storage device, the deploy target computer or an external computer to conduct writing concerning the boot disk image when the I/O request specifies writing concerning the boot disk image.

9. The deploying method according to claim 8, wherein
the deploy target computer further comprises mapping information for managing areas already replicated to the replication destination logical disk and other areas, which are included in the boot disk image stored in the replication source logical disk,
upon detecting an I/O request to the storage device, the disk mapping processing part analyzes the I/O request,
when the I/O request specifies reading the boot disk image, the disk mapping processing part refers to the mapping information, and makes a decision whether an access destination area of the I/O request is already replicated to the replication destination logical disk, and
if the area is not yet replicated to the replication destination logical disk, the disk mapping processing part changes over the access destination of the detected I/O request to the replication source logical disk.

10. The deploying method according to claim 9, wherein as for the mapping information, areas already replicated to the replication destination logical disk and other areas which are included in the boot disk image stored in the replication source logical disk are managed by using 1-bit information.

11. A deployment system comprising the deploy target computer and the storage device according to claim 9,
wherein
the storage device comprises a data reflection part which operates asynchronously with the disk mapping processing part in the deploy target computer, and the replication destination logical disk, and
the data reflection part in the storage device manages areas that are not replicated to the replication destination logical disk and that are included in the boot disk image stored in the replication source logical disk, and executes replication of the boot disk image to the areas that are not replicated.

12. The deploying method according to claim 11, wherein
upon replicating all of the boot disk image stored in the replication source logical disk to the replication destination logical disk, the data reflection part in the storage device gives a notice that the replication has been completed to the disk mapping processing part in the deploy target computer, and
upon receiving the notice, the disk mapping processing part releases a path to the replication source logical disk which stores the boot disk image.

13. The deploying method according to claim 12, wherein after releasing the path to the replication source logical disk, the disk mapping processing part in the deploy target computer stops analysis of the I/O request to the storage device.

14. The deploying method according to claim 11, wherein
the deploy target computer comprises a HBA (Host Bus Adapter) as an interface, and assigns a WWN (World Wide Name) to the HBA as an identifier of the deploy target computer, and
the storage device discriminates the deploy target computer on the basis of the WWN.

15. A program for causing a computer to execute the deploying method according to claim 8.
